(19) United States
(12) Patent Application Publication
(10) Pub. No.: US 2019/0059006 A1
(43) Pub. Date: Feb. 21, 2019

(54) METHOD FOR PERFORMING MEASUREMENT AND DEVICE USING SAME

(71) Applicant: LG ELECTRONICS INC., Seoul (KR)

(72) Inventors: Joonkui AHN, Seoul (KR); Kijun KIM, Seoul (KR); Seonwook KIM, Seoul (KR)

(73) Assignee: LG ELECTRONICS INC., Seoul (KR)

(21) Appl. No.: 16/079,550

(22) PCT Filed: Feb. 22, 2017
(86) PCT No.: PCT/KR2017/001920

§ 371 Date: Aug. 23, 2018

Related U.S. Application Data
(60) Provisional application No. 62/300,039, filed on Feb. 25, 2016.

(51) Int. Cl. H04W 24/02; H04W 24/10; H04W 72/04

(52) U.S. Cl. CPC H04W 24/02; H04W 72/04; H04W 24/10

(57) ABSTRACT

Provided are a method for performing measurement in a wireless communication system and a device using the same. The device measures channel quality on the basis of at least one discovery signal received within a measurement period assumed to have the same transmission power.

### BACKGROUND OF THE INVENTION

### Field of the Invention

The present invention relates to wireless communication, and more particularly, to a method of performing measurement by using a discovery signal in a wireless communication system, and a device using the method.

### Related Art

A next-generation wireless communication system is required to support various user environments and greater communication capacity. Representative issues considered in the next-generation system include a massive machine type communications (MTC) which provides various services anytime anywhere by connecting a plurality of devices, ultra-reliable and low-latency communications (URLLC) considering a service which is sensitive to reliability and latency, or the like.

In a next-generation communication system, cell coverage can be adaptively operated to optimize cell power consumption and to reduce interference between neighboring cells. However, if a change of the cell coverage is not correctly recognized by terminals which are currently receiving a service, a network operation may be less efficient due to an inaccurate radio resource management (RRM) measurement report.

### SUMMARY OF THE INVENTION

The present invention provides a method for performing measurement in a wireless communication system and a device using the same.

In an aspect, a method for performing measurement in a wireless communication system is provided. The method includes receiving, by a wireless device, a transmission configuration to receive a discovery signal, the transmission configuration including a transmission period and transmission duration in which the discovery signal is transmitted, and measuring, by the wireless device, channel quality based on the at least one received discovery signal during a measurement duration assumed to have the same transmission power according to the transmission configuration.

The measurement duration may include at least one transmission duration.

The transmission configuration may include information on a transmission power of the discovery signal used in each measurement duration.

In another aspect, a device for performing measurement in a wireless communication system includes a transceiver configured to transmit and receive a radio signal, and a processor operatively coupled to the transceiver. The processor is configured to receive a transmission configuration to receive a discovery signal, the transmission configuration including a transmission period and transmission duration in which the discovery signal is transmitted, and measure channel quality based on the at least one received discovery signal during a measurement duration assumed to have the same transmission power according to the transmission configuration.

Cell coverage is changed adaptively, thereby optimizing power consumption of a cell and mitigating inter-cell interference.

### BRIEF DESCRIPTION OF THE DRAWINGS

FIG. 1 shows transmission of a discovery signal.

FIG. 2 shows measurement using a discovery signal according to an embodiment of the present invention.

FIG. 3 shows an example of power transmission adjustment for a discovery signal.

FIG. 4 shows transmission of a discovery signal according to an embodiment of the present invention.

FIG. 5 is a block diagram showing a wireless communication system according to an embodiment of the present invention.

### DESCRIPTION OF EXEMPLARY EMBODIMENTS

A wireless device may be fixed or mobile, and may be referred to as another terminology, such as a user equipment (UE), a mobile station (MS), a mobile terminal (MT), a user terminal (UT), a subscriber station (SS), a personal digital assistant (PDA), a wireless modem, a handheld device, etc. The wireless device may also be a device supporting only data communication such as a machine-type communication (MTC) device.

A base station (BS) is generally a fixed station that communicates with the wireless device, and may be referred to as another terminology, such as an evolved-NodeB (eNB), a base transceiver system (BTS), an access point, etc.

Hereinafter, it is described that the present invention is applied according to a 3^{rd} generation partnership project (3GPP) long term evolution (LTE) based on 3GPP technical specification (TS). However, this is for exemplary purposes only, and thus the present invention is also applicable to various wireless communication networks.

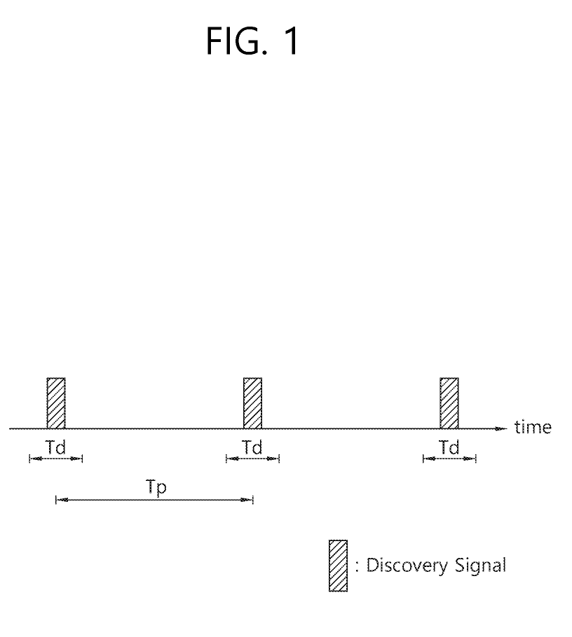

FIG. 1 shows transmission of a discovery signal.

The discovery signal is a signal periodically transmitted by each cell for the purpose of cell discovery, downlink synchronization, downlink measurement, etc.

‘Td’ denotes a transmission duration in which the discovery signal is transmitted. ‘Tp’ denotes a period of the transmission duration. The transmission duration may be given as a subframe or time. For example, if the transmission duration is defined as consecutive 5 subframes, the discovery signal may be transmitted in at least any one of the 5 subframes. Information on Td and Tp may be provided by a BS to each wireless device.

A downlink (DL) signal based on the existing 3GPP LTE may be used as the discovery signal. At least one of a cell specific reference signal (CRS), a primary synchronization signal (PSS), a secondary synchronization signal (SSS), a channel state information-reference signal (CSI-RS) and/or a combination of them may be used as the discovery signal.

In order to adaptively change cell coverage, transmission power of the discovery signal may be changed adaptively. For example, this is because a decrease in the transmission power of the discovery signal leads to a decrease in a distance in which the wireless device can detect the discovery signal, thereby advantageously decreasing cell coverage.

However, if the wireless device currently having access to the existing cell fails to recognize a change in the transmission power of the discovery signal, it may be difficult to normally perform cell discovery and measurement. When a measurement result of the wireless device deteriorates, it is difficult for the BS to recognize whether it is because the transmission power of the discovery signal is decreased or because a channel state of the wireless device deteriorates.

Hereinafter, a method is proposed in which a discovery signal of a wireless device is detected/measured while adaptively changing transmission power of the discovery signal, thereby effectively utilizing a network operation.

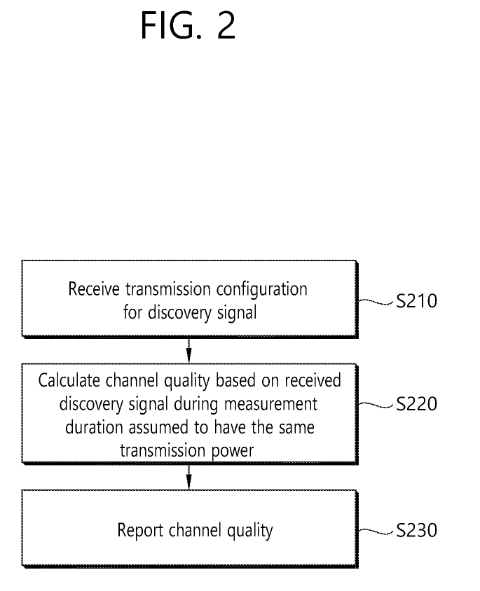

FIG. 2 shows measurement using a discovery signal according to an embodiment of the present invention.

In step S210, a wireless device receives a transmission configuration of the discovery signal from a BS. The transmission configuration may include information on a transmission duration, in which the discovery signal is transmitted, and a period of the transmission duration.

In step S220, the wireless device calculates channel quality on the received discovery signals during a measurement duration assumed to have the same transmission power. The measurement duration is a duration in which the wireless device can assume that received discovery signals have the same transmission power. The measurement duration may include one or more transmission durations. Alternatively, the measurement duration may include a portion of the transmission duration. Information on the transmission duration may be included in the transmission configuration.

If the wireless device calculates the channel quality by averaging measurement values of the transmitted discovery signals by using different transmission power, the channel quality may represent incorrect quality. The wireless device may calculate the channel quality by averaging measurement values obtained using discovery signals received during a time unit in which there is no change in the transmission power of the discovery signal. Therefore, the wireless device may calculate the channel quality by averaging the measurement values of the discovery signals received during the measurement duration, under the assumption that the discovery signals received during the measurement duration have the same transmission power.

In order for the wireless device to calculate a path-loss on the basis of reception power of the discovery signal to adjust uplink transmission power or to utilize it in cell selection, the wireless device needs to correctly know the transmission power of the discovery signal. In one embodiment, the discovery signal may include power information on transmission power. The power information may be transmitted to the wireless device together with the discovery signal. Alternatively, the BS may inform the transmission power of the discovery signal in advance through an RRC message for each transmission duration and/or measurement duration. In another embodiment, a sequence determined based on the transmission power may be transmitted as the discovery signal. A first sequence may be transmitted when first transmission power is used, and a second sequence may be transmitted when second transmission power is used. The BS may select and transmit only one of a plurality of candidate sequences according to the transmission power. Information on the plurality of candidate sequences may be provided in advance to the wireless device.

If a period in which the transmission power for the discovery signal is changeable is relatively long, the BS may report information on transmission power through additional broadcast signaling. Assume that ‘T_var’ denotes the period in which the transmission power for the discovery signal is changeable. If transmission power at an n-th T_var duration T_var(n) is changed in comparison with a previous T_var duration T_var(n−1), the BS may broadcast information on transmission power at T_var(n) within T_var(n−1). The wireless device does not utilize the discovery signal received at T_var(n) when calculating channel quality at T_var(n−1).

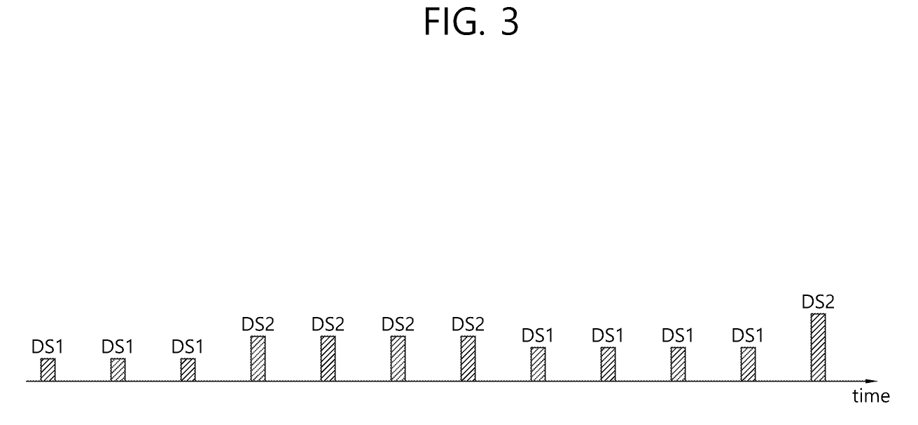

FIG. 3 shows an example of power transmission adjustment for a discovery signal.

If the discovery signal is not directly used in calculation of a path-loss, transmission power itself of the discovery signal may not be necessarily reported to a UE. Therefore, a BS may inform a wireless device of only whether there is a change in transmission power instead of a transmission power value itself.

The discovery signal and to-be-transmitted M(M>=1)-bit status information may be used to inform whether current transmission power is equal to previous transmission power or whether the current transmission power is different from the previous transmission power. If the current transmission power is different from the previous transmission power, a value of the M-bit status information may be updated. For example, if a difference between the current transmission power and the previous transmission power is greater than or equal to a specific value, a value of the status information may be updated from 0 to 1. Thereafter, if the difference between the current transmission power and the previous transmission power is greater than or equal to the specific value, the value of the status information may be updated from 1 to 0.

Three discovery signals DS1 to be first transmitted have the same transmission power. DS2 has higher transmission power than DS1. Therefore, the value of the status information is updated. When DS1 is transmitted again after DS2, the value of the status information is updated again.

Returning to FIG. 2, in step S230, the wireless device transmits a channel report having channel quality measured based on the discovery signal. Any one of reference signal received power (RSRP), received signal strength indicator (RSSI), and reference signal received quality (RSRQ) may be used as an indicator indicating channel quality.

The channel report may include information on reception timing of a discovery signal used in measurement of the channel quality.

The channel report may include information on transmission timing of the discovery signal used in measurement of the channel quality.

The BS may interpret the reported channel quality by considering the reported reception timing or transmission power of the discovery signal.

The aforementioned methods may be applied not only to a channel quality report for a serving cell but also a channel quality report for a neighboring cell. That is, it may be transmitted through a discovery signal received from the serving cell and/or a discovery signal received from the neighboring cell.

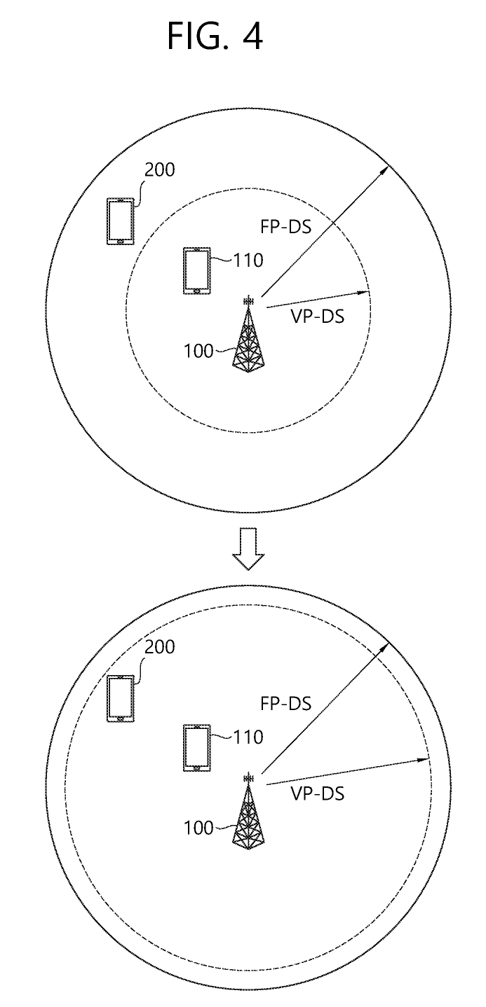

FIG. 4 shows transmission of a discovery signal according to an embodiment of the present invention.

Adjusting of cell coverage according to requirements such as a location, data rate, or the like of a wireless device to be supported by a cell may be useful for increasing power efficiency of a network and reducing inter-cell interference. However, if a new UE desires to receive a service at a location which cannot be covered by neighboring cells operating with small coverage, it is necessary for the network to be able to recognize this and to properly increase cell coverage again.

A BS 100 may transmit a varying power-discovery signal (VP-DS) and a fixed power-discovery signal (FP-DS).

The VP-DS is a discovery signal of which transmission power changes, as described in the embodiment of FIG. 3. The VP-DS is transmitted by using transmission power enough to cover a first wireless device 110 to which the BS 100 currently provides a service.

The FP-DS is a discovery signal having fixed power. The FP-DS may be transmitted by using transmission power enough to cover fixed cell coverage (e.g., maximum cell coverage). A transmission period of the FP-DS may be greater than a transmission period of the VP-DS. The wireless device may assume that the transmission power of the FP-DS is always the same.

If a second wireless device 200 desires to receive a service from the BS 100, the BS may increase the transmission power of the FP-DS to increase cell coverage.

To distinguish the FP-DS and the VP-DS, the following method may be applied. For example, the FP-DS and the VP-DS may be transmitted using different sequences. For another example, the FP-DS and the VP-DS may be transmitted at different frequency bands. For another example, the FP-DS and the VP-DS may be transmitted at different transmission timings.

The FP-DS may be particularly useful for simplifying measurement on neighboring cells. The wireless device may use only the FP-DS to measure reception quality for the neighboring cells. The wireless device may use only the VP-DS to measure reception quality for the serving cell. The wireless device may report channel quality using the VP-DS and channel quality using the FP-DS. Each of a transmission configuration for the VP-DS and a transmission configuration for the FD-DS may be given to the wireless device.

The wireless device (or UE) may use channel quality measured using a discovery signal (FP-DS and/or VP-DS) transmitted by the serving cell in radio link synchronization (RLS) management for the serving cell. The RLS management refers to an operation in which the wireless device evaluates reception quality in the serving cell for a long term to determine whether to maintain or release a connection with the serving cell. If it is determined to release the connection, the wireless device may directly release the connection or may release the connection after transmitting a connection release request to a network.

However, when transmission power of a discovery signal is changeable, an RLS failure may unnecessarily occur frequently if channel quality of all discovery signals is used in statistics for RLS management irrespective of the transmission power. Therefore, the wireless device may use a discovery signal transmitted with at least specific transmission power in channel quality statistics for the RLS management. Alternatively, the wireless device may use channel quality of each discovery signal in quality statistics for the RLS management by converting it to channel quality when assuming specific reference transmission power. The wireless device may use only the FP-DS in channel quality statistics for the RLS management.

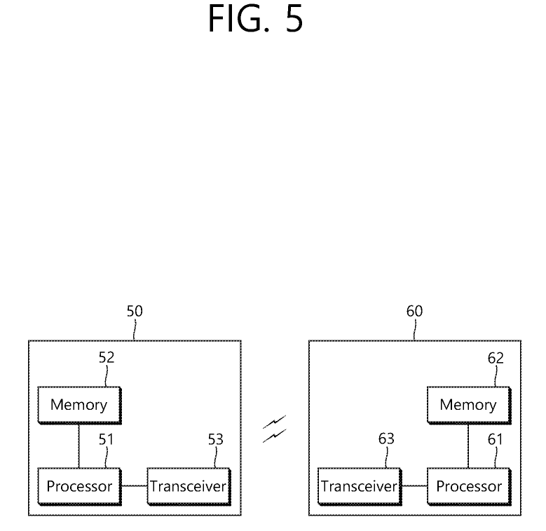

FIG. 5 is a block diagram showing a wireless communication system according to an embodiment of the present invention.

A wireless device 50 includes a processor 51, a memory 52, and a transceiver 53. The memory 52 is coupled to the processor 51, and stores various instructions executed by the processor 51. The transceiver 53 is coupled to the processor 51, and transmits and/or receives a radio signal. The processor 51 implements the proposed functions, procedures, and/or methods. In the aforementioned embodiment, an operation of the UE may be implemented by the processor 51. When the aforementioned embodiment is implemented with a software instruction, the instruction may be stored in the memory 52, and may be executed by the processor 51 to perform the aforementioned operation.

A BS 60 includes a processor 61, a memory 62, and a transceiver 63. The BS 60 may operate in an unlicensed band. The memory 62 is coupled to the processor 61, and stores various instructions executed by the processor 61. The transceiver 63 is coupled to the processor 61, and transmits and/or receives a radio signal. The processor 61 implements the proposed functions, procedures, and/or methods. In the aforementioned embodiment, an operation of the BS may be implemented by the processor 61.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for performing measurement in a wireless communication system, the method comprising:
receiving, by a wireless device, a transmission configuration to receive a discovery signal, the transmission configuration including a transmission period and transmission duration in which the discovery signal is transmitted; and
measuring, by the wireless device, channel quality based on the at least one received discovery signal during a measurement duration assumed to have the same transmission power according to the transmission configuration.

2. The method of claim 1, wherein the measurement duration includes at least one transmission duration.

3. The method of claim 1, wherein the transmission configuration includes information on a transmission power of the discovery signal used in each measurement duration.

4. The method of claim 1, wherein at least one discovery signal received in the measurement duration includes status information on a used transmission power.

5. The method of claim 4, wherein the status information indicates whether the used transmission power is changed.

6. The method of claim 1, further comprising:
transmitting, by the wireless device, a channel report including the channel quality.

7. The method of claim 6, wherein the channel report further includes information on timings of the at least one received discovery signal used to measure the channel quality.

8. The method of claim 6, wherein the channel report further includes information on transmission powers of the at least one received discovery signal used to measure the channel quality.

9. The method of claim 1, further comprising:
receiving, by the wireless device, a discovery signal having a fixed transmission power.

10. A device for performing measurement in a wireless communication system, the device comprising:
a transceiver configured to transmit and receive a radio signal; and
a processor operatively coupled to the transceiver and configured to:
receive a transmission configuration to receive a discovery signal, the transmission configuration including a transmission period and transmission duration in which the discovery signal is transmitted; and
measure channel quality based on the at least one received discovery signal during a measurement duration assumed to have the same transmission power according to the transmission configuration.

12. The device of claim 10, wherein the transmission configuration includes information on transmission power of the discovery signal used in each measurement duration.

13. The device of claim 10, wherein at least one discovery signal received in the measurement duration includes status information on a used transmission power.
